(19) United States
(12) Patent Application Publication
(10) Pub. No.: US 2013/0186576 A1
(43) Pub. Date: Jul. 25, 2013

(54) Settling Chamber for Separation of Large, Plugging Particles Upstream of A Hydroclone

(71) Applicants: Daniel P. Bjorklund, Waukesha, WI (US); Robert T. Chapados, Edgerton, WI (US); James M. Marlett, Menomonee Falls, WI (US); Robert W. Sweetman, Waukesha, WI (US)

(72) Inventors: Daniel P. Bjorklund, Waukesha, WI (US); Robert T. Chapados, Edgerton, WI (US); James M. Marlett, Menomonee Falls, WI (US); Robert W. Sweetman, Waukesha, WI (US)

(21) Appl. No.: 13/745,303

(22) Filed: Jan. 18, 2013

Related U.S. Application Data
(60) Provisional application No. 61/588,266, filed on Jan. 19, 2012.

(51) Int. Cl. B01D 1/30; B01D 1/06

(52) U.S. Cl. CPC B01D 1/30; B01D 1/065
USPC 159/49; 210/513; 210/800

(57) ABSTRACT

Evaporation technology is commonly used to to treat process waters that contain low solubility salts. The technology typically used is a brine boncentrator which uses seeded slurry techniques internal to the falling film evaporator which allows these scaling salts to co-precipitate with the seed crystals instead of scaling on the heat transfer surface. Such systems often employ hydroclones to recover and recycle seed crystals that would otherwise leave the process with the brine blowdown stream. These hydroclones (or other separation devices) often have regions of tight clearance that are susceptible to plugging which can lead to suboptimal process availability and greater maintenance obligations. The inventors have developed an apparatus called a “settling chamber” for separating large solid particles from the feed stream to the hydroclone to eliminate plugging, improve availability and reduce maintenance requirements.

### CROSS-REFERENCE TO RELATED APPLICATIONS

This application claims priority to U.S. Provisional Patent Application No. 61/588,266, filed on Jan. 19, 2012, and incorporated by reference herein.

### BACKGROUND OF THE INVENTION

Vertical tube falling film evaporators (“VTFF evaporators”) are used in a multitude of applications for evaporation of brines with high concentrations of scaling components. For example, they may be used in applications relating to fossil fuel extraction. They may also be used in water purification for further use in industrial applications.

VTFF evaporators typically maintain a seed crystal bed to minimize scaling of the heat transfer surface. These seed crystal beds typically include calcium sulfate crystals that act as the seed crystal, though other seed crystals or nucleation sites are possible. Such evaporators are typically called brine concentrators. Brine concentrators operate with a seed bed that forms the substrate for scaling components to precipitate upon in preference to the heat transfer surface. Precipitation of the scaling components on the substrate instead of the heat transfer surface extends the time between cleanings, simplifies cleaning procedures and improves the energy efficiency of the evaporation process.

Unfortunately, conventional brine concentrator evaporation is not without complications. During operation, the brine concentrator will continuously blowdown a portion of the concentrated brine to maintain steady-state operation. This brine blowdown stream will remove a fraction of the seed crystal from the process along with the brine. To maintain a desired seed crystal concentration during steady-state operation, an operator typically needs to compensate for this seed crystal loss. This is commonly done in one or more ways. For example, an operator may add chemicals to precipitate and grow additional seed crystals in-situ. An operator may also prepare seed crystals external to the process and add as a solid or thick slurry. Finally, an operator may use a hydroclone (or other solid/liquid separation device) to recover a fraction of the suspended seed crystals and recycle them to the process.

In the brine concentration process, it has been found that large solid particles can accumulate and cause plugging in the hydroclone (or other separation device). This is a source of increased maintenance required for disassembly and unplugging, loss of efficiency in the evaporative process and increased potential of premature scaling of the evaporation system.

### BRIEF SUMMARY OF THE INVENTION

Embodiments of the invention reduce or eliminate a significant cause of plugging inherent in the use of solids separation devices. This is particularly helpful in brine concentrators or other technology requiring solids separation device for correct operation. The technology is simple, requiring with no moving parts, and removes may remove larger particles known to plug solids separation devices.

Large particles may be removed from a feed stream to a hydroclone by reducing the velocity of an upward flowing stream to allow larger particles to settle back to the system and be recycled without the use of equipment that might plug or require cleaning more frequently than the evaporator. Separation by gravity allows heavy solids to settle back to the main brine stream and requires no pump for the separation of large particles from a feed stream to the hydroclone.

Some embodiments of the invention include baffles internal to falling film evaporators. Others include internal or external tanks. Still others include tanks on external piping; for example, in one embodiment piping to a hydroclone includes a settling tank.

### BRIEF DESCRIPTION OF THE FIGURES

FIG. 1 shows a solids settling region that is a large tube internal to an evaporator.

FIG. 2 shows a solids settling region that is a baffle internal to an evaporator.

FIG. 3 shows a solids settling region that is a tank that is part of recirculation piping attached to an evaporator.

FIG. 4 shows a solids settling region that is a large tank external to the evaporator.

FIG. 5 is a flowchart that shows flows associated with having a solids settling region that is a large tube internal to the evaporator.

FIG. 6 shows a flow diagram of a solids settling region in association with an evaporator.

### DETAILED DESCRIPTION OF THE INVENTION

Hydroclones and other solids separation devices useful in VTFF evaporators (specifically, brine concentrators) often include regions of low clearance. These regions are susceptible to plugging. Embodiments of the invention prevent larger particles from flowing to a hydroclone (or other solids separation device), thereby reducing or eliminating the potential for plugging. Reducing plugging or potential plugging, in turn, improves the brine concentrator's efficiency, reduce maintenance requirements and enhance the process's availability.

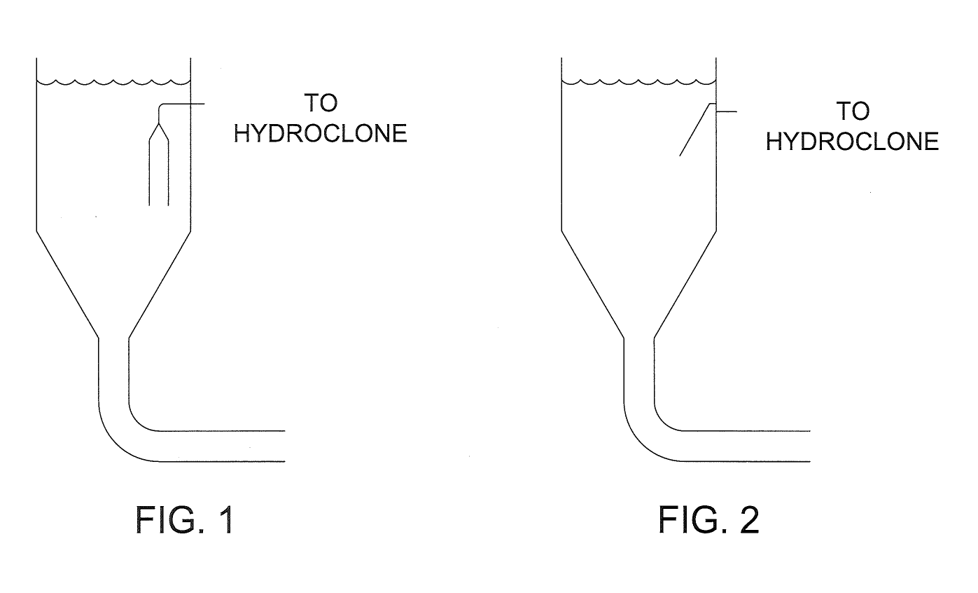

Embodiments of the invention include a solids settling region upstream of a hydroclone. This settling region which can have the form of a large tube or tank, as shown, for example, in FIGS. 1, 3, and 4. In another embodiment the settling region is an integral baffle forming a quiescent region where larger particles can settle. An example of this embodiment is shown in FIG. 2.

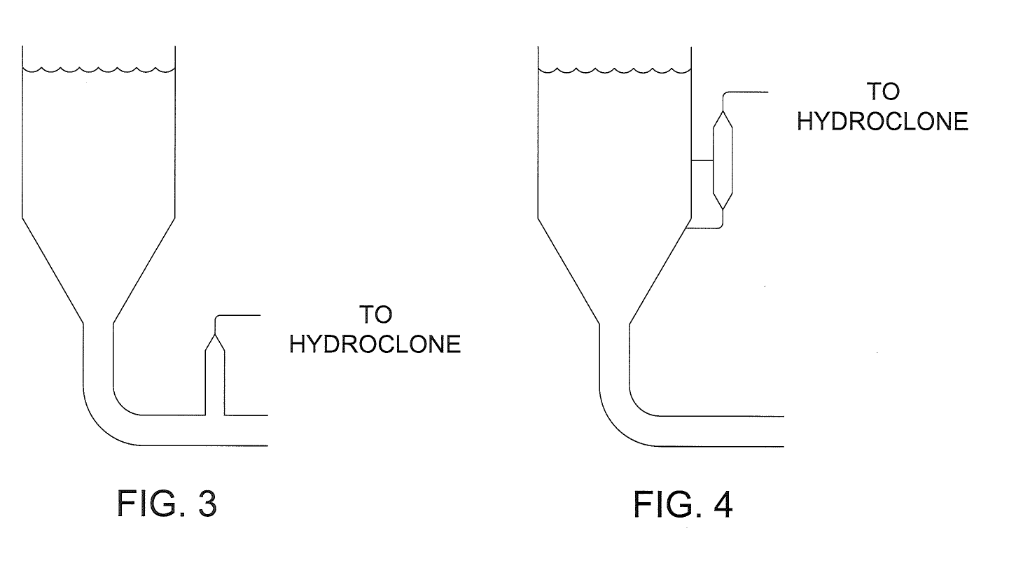

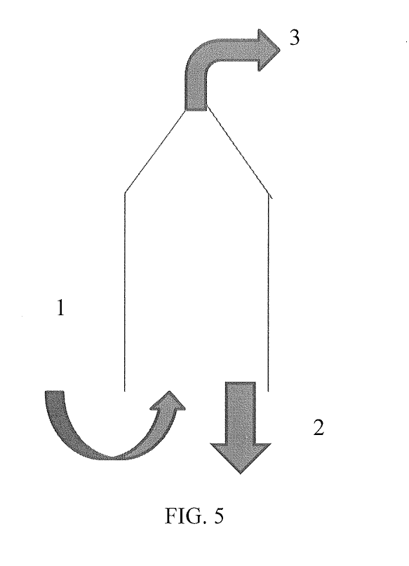

Solids settling regions can be located either internally to the evaporator, as shown in FIGS. 1 and 2. They may also be located externally to the evaporator, as shown in FIG. 4, or as a part of recirculation piping, as shown in FIG. 3. This flexibility allows the settling chamber to be installed in any brine slurry region where the hydroclone brine feed can be removed from the evaporator.

One embodiment of the invention is shown in FIG. 5. FIG. 5 depicts the flows associated with FIG. 1, in which a settling chamber is located inside a VTFF evaporator. FIG. 5 shows a solids-laden brine entering the “settling chamber” as stream 1. In this quiescent zone the heavy solids, stream 2, settle to the bottom of the chamber. Stream 3 exits the top of the settling chamber free of large particles and containing only the smaller particles that would not plug the hydroclone.

The settling chamber reduces the velocity of the brine flowing to the hydroclone solids separation device. This encourages larger particles to settle, typically through gravity separation. This eliminates the presence of large suspended particles flowing to the hydroclone separation device and creates a clarified brine water that contains only small seed crystals to flow from the top of the settling chamber to the hydroclone or other solids separation device. By limiting the upwards velocity of the brine to less than 0.1 ft/sec, particles with sizes greater than 200 micron can be expected to settle.

The size, both cross sectional area and length, of the apparatus are determined by applying a variation of Stokes Law. Stokes Law is applicable to fluids flowing with a Reynolds number of less than 1. The Intermediate Law applies to Reynolds numbers between 2 and 500. Knowing the maximum particle size allowable, particle shape, solid and liquid densities and Drag coefficient allows a prediction of the free settling velocity of the particles for a given up-flow flow velocity. Since we are operating in the Intermediate range, the Drag coefficient can be approximated. From the Drag Coefficient, we can determine the allowable liquid upflow velocity and properly size the settling tank to permit efficient gravity separation of suspended particles.

Equations used are:

$$\begin{matrix}{C}_{D} = \frac{18.5}{{N}_{Rep}^{0.6}} \\ {F}_{d} = \frac{2.31 {π ( {u}_{t} {D}_{p} )}^{1.4} {μ}^{0.6} {ρ}^{0.4}}{{g}_{c}} \\ {u}_{t} = \sqrt{\frac{2 {g}_{c} ( {ρ}_{p} - ρ ) m}{{A}_{p} {ρ}_{p} {C}_{D} ρ}} \\ {U}_{o} = \frac{( 2 {g}_{c} {F}_{D} )}{{C}_{D} ρ {A}_{p}} \\ D = \sqrt{\frac{4 V}{{u}_{o} π}} & \\ \begin{matrix}{A}_{p} & Projected area of particle , {ft}^{ 2} \\ {C}_{D} & Drag Coefficient , dimensionless \\ D & Diameter of Apparatus , ft \\ {D}_{P} & Projected diameter of particle , ft \\ {F}_{D} & Total Drag Force , {lb}_{f} \\ {g}_{c} & Gravitational Constant , 32.2 ft \text{/} sec \text{/} sec \\ m & Mass of particle , lb \\ {N}_{ReP} & Reynolds number of Particle , {D}_{P} {u}_{T} {ρ}_{P} \text{/} μ \\ {u}_{t} & Terminal Velocity of Particle , ft \text{/} sec \\ {u}_{o} & Liquid upflow velocity , ft \text{/} sec \\ V & Volumetric flowrate of liquid , {ft}^{ 3} \text{/} sec \\ μ & Absolute Viscosity of liquid , lb \text{/} ft \text{-} sec \\ ρ & Density of liquid , lb \text{/} {ft}^{ 3} \\ {ρ}_{P} & Density of particle , lb \text{/} {ft}^{ 3}\end{matrix} & \end{matrix}$$

Further information on Stokes Law calculations may be found, for example, in McCable & Smith, Unit Operations of Chemical Engineering, Second Edition, McGraw-Hill, 1967, pp 162-171. That document is incorporated by reference herein.

Some embodiments of the invention include a baffle to reduce up flow velocity of brine. The baffle creates an area where the up flow velocity of the brine is reduced allowing the particles to settle in a quiescent zone. The effectiveness of the particle removal is dependent on the upward velocity of the brine. The shape of the baffle, square, rectangular, round oval or other shape is immaterial to the design as long as the velocity is reduced and a quiescent zone created.

### EXAMPLE

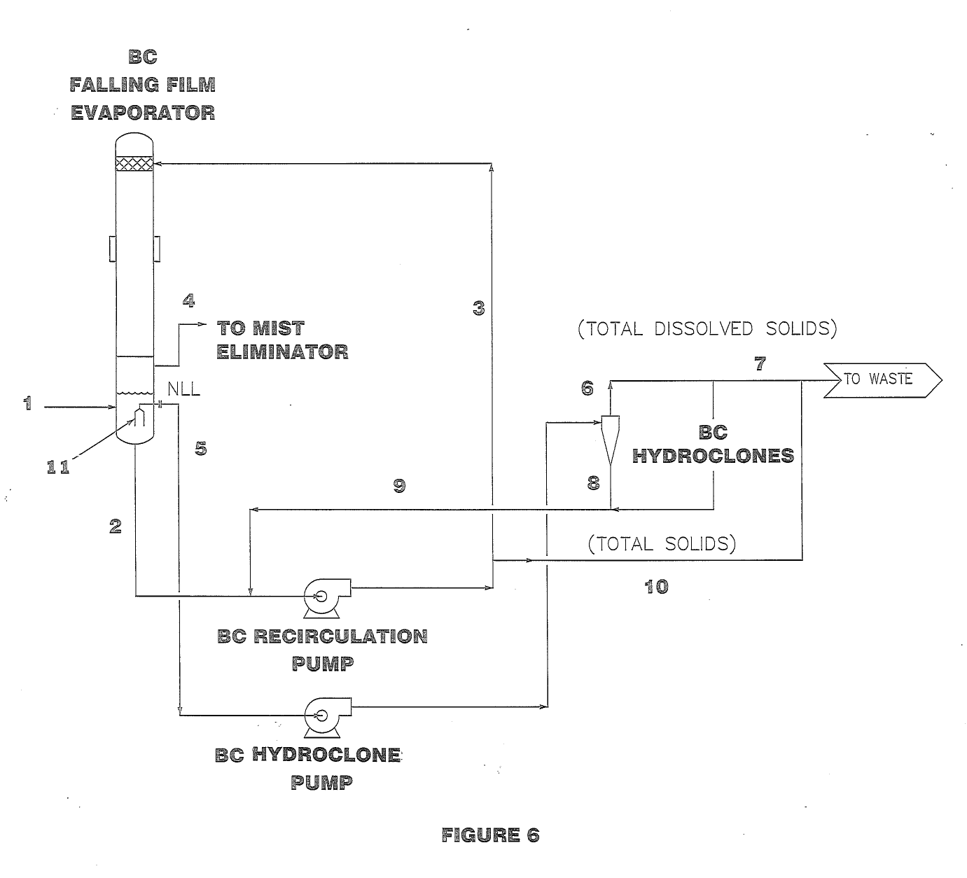

FIG. 6 shows a flow diagram of an apparatus as it might be installed inside an evaporator. Feed enters the evaporator as stream 1. The evaporator includes a cylindrical vessel 11 internal to the evaporation vessel. It is this cylindrical vessel that creates a quiescent zone for reduction of flow velocity. Feed mixes with the existing brine in the evaporator and flows to the recirculation pump as stream 2. The mixture of hydroclone underflow, hydroclone overflow and circulating brine stream 3 is pumped to the evaporator where it is distributed over the heat transfer surface. A portion of the brine is vaporized stream 4 and exits the evaporator. Another portion of the concentrated brine, stream 5, is pumped to the hydroclone for separation into a heavy solids phase, underflow stream 8, and light solids phase, overflow, stream 6. A portion of the overflow is discharged from the system as required by the process as stream 7 with the remainder recycled mixing with stream 8 to form stream 9 and back to the evaporator. Stream 10 is discharged from the evaporator to maintain the required suspended solids level and prevent the buildup of large solids in the system.

The evaporator described is used to concentrate low solubility scaling salts. In so doing, it is important to maintain a circulating seed bed to provide sites for the scaling components to deposit other than the heat transfer surface. Failure to do this results in premature scaling of the heat transfer surface and increased equipment downtime due to cleaning. Since many types of brines do not contain the correct concentration of seeding components, it is necessary to limit the discharge of these components from the system to their natural levels while maintaining a higher concentration of these components in the system. The correct operation of the hydroclone is essential to this end. The passages in the underflow of the hydroclone are small to achieve the correct separation of solids from stream 5. When these passages plug due to large particles, the solids required for correct operation of the evaporator are discharged through the overflow, stream 6, from the evaporator. This reduces the sites available for deposition of the scaling components, shortening the time between cleaning the evaporator, increasing maintenance of the evaporator and hydroclone and increasing operating costs.

Demonstration of Effectiveness of the Apparatus

The benefit of the invention, extended operation of hydroclones without plugging, was demonstrated by the installation of the apparatus in a full sized operating evaporator. In this example, the evaporator was a Brine Concentrator operating in a seeded mode. These seeds consisted primarily of calcium sulfate and calcium fluoride which is standard for this operation. The seed concentration ranged between 5 and 10%ᵥ. The system had four (4) Krebs PC-2 hydroclones installed. During the operation, all four hydroclones were in operation. Brine from the evaporator flowed upwards through the apparatus. The apparatus was sized to for a liquid upflow velocity of less than 0.1 FPS. The particle size targeted for removal was greater than 175 micron. The apparatus was installed inside the Brine Concentrator. The outlet of the apparatus was directed to the Hydroclone Pump which pumped the brine through the hydroclones. The underflow of the hydroclones was directed back to the line feeding the recirculation pump. The overflow of the hydroclones was split with a portion of the overflow being discharged from the system to maintain the concentration in the evaporator and the remainder being directed back to the evaporator. FIG. 6 depicts the arrangement of the apparatus and other associated equipment. During operation of the evaporator before the installation of the apparatus, the hydroclones were not able to be operated for more than two (2) days before plugging. The apparatus was installed and observed for a period of seven (7) days. The operation of the hydroclones was monitored each shift to determine if they had plugged. During the monitoring period, no plugging was observed.

We claim:

1. An apparatus for removing large solid particles from an evaporator stream being fed to a hydroclone downstream of said evaporator, comprising:
a circulating slurry comprising a brine-concentrating seed bed, and
a settling region downstream of said brine-concentrating seed bed, wherein said settling region decreases a fluid flow velocity between an evaporator and a hydroclone downstream of said evaporator, thereby removing, by gravity separation, at least a portion of solid particles flowing from said brine-concentrating seed bed to said hydroclone.

2. The apparatus of claim 1, wherein said settling region prevents said particles from being fed to the hydroclone.

3. The process of claim 2, wherein said hydroclone has an underflow, and wherein said underflow of the hydroclone is directed back to a recirculating water to maintain a circulating slurry seed bed sufficient to retard scaling of a heat transfer surface in an evaporator.

4. The process of claim 2 wherein hydroclone has an overflow, and wherein said overflow is either discharged or directed back to the recirculation water.

5. The apparatus of claim 1, wherein the settling region is a cylindrical vessel.

6. The apparatus of claim 5 wherein the cylindrical vessel is mounted vertically.

7. The apparatus of claim 1, wherein the settling region is a baffle mounted within an evaporation vessel.

8. The apparatus of claim 5, wherein the cylindrical vessel is installed inside an evaporation vessel.

9. The apparatus of claim 5, wherein the cylindrical vessel is installed external to the evaporation vessel

10. The apparatus of claim 5 wherein the cylindrical vessel is installed in a line of a recirculation pump suction.

11. The apparatus of claim 1, wherein the evaporator is a vertical tube falling film evaporator.

12. A method for decreasing plugging of a hydroclone downstream of a a circulating slurry comprising a brine-concentrating seed bed serving a vertical tube falling-film evaporator, comprising:
mixing a feedstream with a brine in an evaporator;
allowing the feedstream/brine mixture to flow to a recirculation pump, where it is mixed with a hydroclone overflow and a hydroclone underflow;
pumping the feedstream/brine/overflow/underflow mixture to an evaporator, wherein at said mixture passes through a settling chamber that removes at least a portion of particles from said mixture;
distrbuting the feedstream/brine/overflow/underflow mixture over a heat transfer surface of an evaporator;
vaporizing a portion of the mixture;
sending a portion of the mixture to a hydroclone for separation into a heavy solids phase, an underflow, and an overflow; and
removing at least a portion of said heavy solids phase from said mixture.
